(19) United States
(12) Patent Application Publication
(10) Pub. No.: US 2017/0123446 A1
(43) Pub. Date: May 4, 2017

(54) ON-CHIP SELF CALIBRATION OF IO DRIVER IMPEDANCE FOR PVT VARIATION USING DYNAMICALLY ADJUSTED INTERNAL REFERENCE

(71) Applicant: SanDisk Technologies Inc., Plano, TX (US)

(72) Inventors: Gopikrishna Siddula, Bangalore (IN); Shiv Harit Mathur, Bangalore (IN)

(21) Appl. No.: 14/928,751

(22) Filed: Oct. 30, 2015

(51) Int. Cl. G05F 3/24

(52) U.S. Cl. CPC G05F 3/245

(57) ABSTRACT

A PVT calibration system of an electronic device may select a temperature band of a plurality of temperature bands based on a detected device temperature. A comparator of the calibration system may compare a process characterization voltage with one or both of an upper bound level and a lower bound level of a reference voltage band associated with the selected temperature band. Based on the comparison, the PVT calibration system may identify a process characterization of the electronic device. The PVT calibration system may use the identification, along with identified device temperature and supply voltage levels to calibrate an impedance of I/O driver circuitry of the electronic device.

### BACKGROUND

An electronic device may include an interface to communicate with other another electronic device using a communications bus. In order to send and receive signals on the communications bus, the interface may include input/output (I/O) driver circuitry that is configured to drive lines of the communications bus, such as by pulling up and down the levels of the voltages. Output impedances among I/O driver circuitries of different electronic devices or output impedance of I/O driver circuitry of a single electronic device may vary due to process, voltage, and temperature (PVT) variations resulting from manufacturing (e.g., fabrication) imperfections and/or fluctuations in temperature or voltage during operation of the electronic devices. The output impedance variations may be relatively large, such as on the order of plus/minus 40-45 percent. Such large variation or spread in impedance may cause system-level timing issues, deterioration in signal integrity, and higher power consumption, which may otherwise be avoided or at least reduced if the variation can be made smaller or non-existent.

A calibration process may be used to reduce I/O driver impedance variations by detecting and compensating for PVT variations. Some existing calibration processes may utilize a reference voltage that is constant in the presence of PVT variations. Such calibration processes may use external or off-chip circuit components (e.g., a resistor) or signals (e.g., a clock signal) for generating the reference. However, due to size and/or packaging requirements, it may be impractical or impossible for some electronic devices, such as memory devices, to use external components or signals for calibration. As such, internal or on-chip calibration circuitry and processes may be desirable.

### BRIEF DESCRIPTION OF THE DRAWINGS

The accompanying drawings, which are incorporated in and constitute a part of this specification illustrate various aspects of the invention and together with the description, serve to explain its principles. Wherever convenient, the same reference numbers will be used throughout the drawings to refer to the same or like elements.

FIG. 1 is a block diagram of an example calibration system.

FIG. 2 is a schematic diagram of a plurality of voltage bands associated with a plurality of temperature bands with reference to process detection curves as functions of device temperature.

FIG. 3 is a flow chart of an example method of identifying a process characterization.

FIG. 4 is a flow chart of an example method of performing an initial calibration process.

FIG. 5 is a flow chart of an example method of performing a subsequent calibration process.

FIG. 6 is a block diagram of an example non-volatile memory system configured with the calibration system of FIG. 1 and that can perform the methods of FIGS. 3-5.

### DETAILED DESCRIPTION OF PRESENTLY PREFERRED EMBODIMENTS

Overview

As mentioned in the background section, on-chip PVT calibration systems that accurately identify process characterization, supply voltage, and device temperature conditions and/or levels may be desirable. In one example embodiment, a calibration system for an electronic device may include a reference generator and indication circuitry. The reference generator may be configured to output a reference voltage at a level based on a device temperature of the electronic device. The indication circuitry may be configured to output a process indication signal based on a comparison of the reference voltage and a process detection voltage. The process indication signal may indicate a process characterization of the electronic device.

In another example embodiment, a calibration method may be performed. The calibration method may include: receiving, with a controller, a temperature indication of a device temperature of an electronic device; selecting, with the controller, a temperature band of a plurality of temperature bands that corresponds to a detected temperature of an electronic device; outputting, with a reference generator, a reference voltage at a level that corresponds to the selected temperature band; comparing, with comparator circuitry, a process detection voltage and the reference voltage; and setting, with the controller, an impedance of driver circuitry of the electronic device based on comparing the process detection voltage with the reference voltage.

In another example embodiment, a calibration system may include a controller configured to: select a temperature band of a plurality of temperature bands that corresponds to a detected temperature of an electronic device, output a control signal for generation of a reference voltage at a level corresponding to the selected temperature band, receive a process indication signal indicative of a level of a process detection voltage relative to the level of the reference voltage, generate a calibration signal to calibrate an impedance of driver circuitry based on the process indication signal, and output the calibration signal to the driver circuitry.

In some example embodiments, a controller may be configured generate a reference control signal based on the temperature indication signal, and output the reference control signal to the reference generator. The reference generator may be configured to output the reference voltage at the level based on receipt of the reference control signal.

In some example embodiments, the controller may be further be configured to determine a temperature band of a plurality of temperature bands that corresponds to the device temperature indicated by the temperature indication signal, and generate the reference control signal based on the determined temperature band. The level at which reference generator is configured to output the reference voltage may correspond to the determined temperature band.

In some example embodiments, the level at which the reference generator is configured to output the reference voltage may be one of an upper bound level or a lower bound level of a reference voltage band corresponding to the determined temperature band.

In some example embodiments, the reference generator may further be configured to output the reference voltage at the other of the upper bound level or the lower bound level for a determination of the process characterization of the electronic device.

In some example embodiments, the reference voltage may include a first reference voltage, and the indication circuitry may further be configured to output the temperature indication signal based on a comparison of a second reference voltage and a temperature detection voltage output from a temperature detection circuit.

In some example embodiments, the reference generator may further be configured to, in response to receipt of the control signal, adjust a constant reference voltage to generate the reference voltage at the level.

In some example embodiments, a controller may be configured to receive the process identification signal, generate an input/output (I/O) driver calibration signal based on the process identification signal, and output the I/O driver calibration signal to an I/O driver circuit for calibration of an impedance of the I/O driver circuit.

In some example embodiments, a regulator may be configured to receive a supply voltage and generate a regulated voltage based on the supply voltage. In addition, process detection circuitry may be configured to generate the process detection voltage based on the regulated voltage.

In some example embodiments, after the impedance is set, the controller may detect a change in the device temperature or a supply voltage level, and adjust the impedance of the driver circuitry to compensate for the detected change in the device temperature or supply voltage level.

In some example embodiments, the reference generator and the comparator circuitry may be configured on the same chip.

In some example embodiments, the detected temperature may be within the selected temperature band.

Other embodiments are possible, and each of the embodiments can be used alone or together in combination. Accordingly, various embodiments will now be described with reference to the attached drawings.

### Exemplary Embodiments

The present description describes a calibration system of an electronic device that is configured to calibrate an output impedance of input/output (I/O) driver circuitry of the electronic device in order to compensate for process, voltage, and temperature (PVT) variations. The calibration system may be configured to set or adjust a level of a reference voltage based on temperature of the electronic device. Doing so may minimize the effect that the device temperature has on a process characterization portion of the calibration process. A reference generator that generates the reference voltage may be on-chip or internal with other circuit components and fit with the form factor of the electronic device so that components and/or reference signals external to the packaging of the electronic device are not needed. The calibration process may also include a regulator that minimizes the effect that supply voltage variation has on the process characterization portion. In addition, the calibration process may be considered a self-calibration process in that the calibration system may be configured to determine when to perform (and re-perform) calibration in the presence of PVT variations on its own without receipt of an external input.

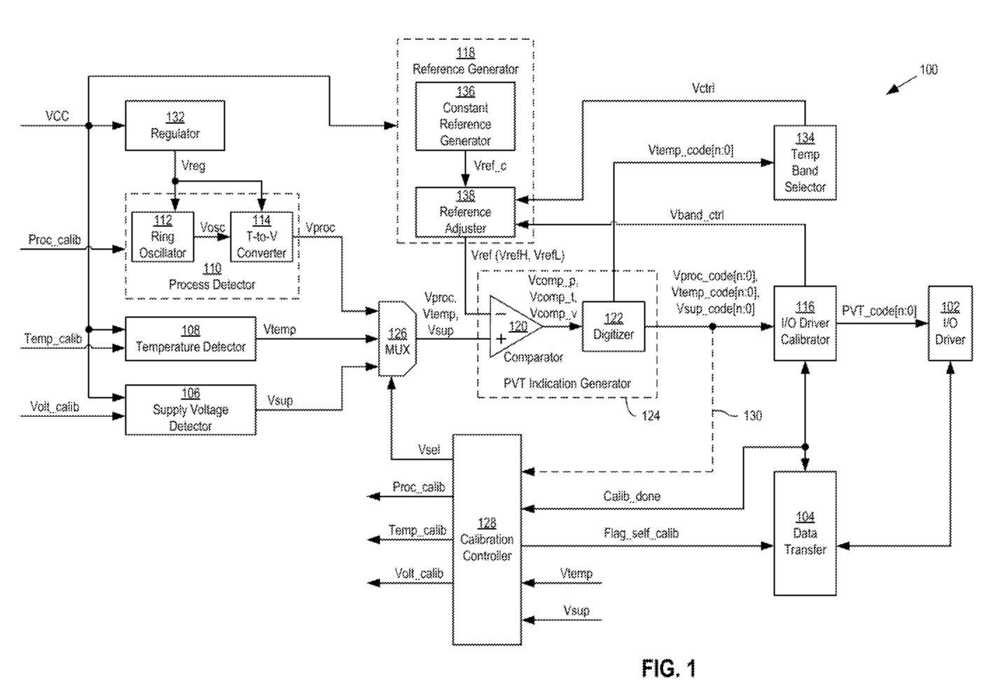

FIG. 1 shows a block diagram of an example calibration system 100 in communication with I/O driver circuitry 102 of an electronic device. In general, the I/O driver circuitry 102 may be configured to generate signals on a communications bus by pulling up and down voltages on lines of the bus, and receive signals that are generated by another driver circuit communicating on the bus. The I/O driver circuitry 102 may communicate with and/or be controlled by a data transfer module 104 for the communication of data.

The I/O driver circuitry 102 may have an associated impedance that affects its performance characteristics, such as those related to timing, signal integrity, and/or power consumption. The I/O driver circuitry 102 may be configured such that its impedance can be set or adjusted to a desirable level. For example, the I/O driver circuitry 102 may include a plurality of I/O driver circuitry segments that can be connected in parallel with each other. An example segment configuration may include a transistor (e.g., a metal-oxide-semiconductor field-effect transistor (MOSFET)) and a resistor. The impedance of the I/O driver circuitry 102 may be set or adjusted by setting or adjusting the number of segments of a total set of segments of the I/O driver circuitry 102 that are connected in parallel. The components of the calibration system that may be used to calibrate the impedance of the I/O driver circuitry 102 are now described.

The calibration system 100 may include detector circuitry to compensate for PVT variations, including supply voltage detection circuitry 106, temperature detection circuitry 108, and process detection circuitry 110. Components of the electronic device in which the calibration system 100 is implemented may be powered by a supply voltage VCC. The supply voltage detection circuitry 106 may be configured to detect a level of the supply voltage VCC and generate a supply voltage detection voltage Vsup that indicates the detected level. Accordingly, the supply voltage detection circuitry 106 may change or adjust the level of the supply voltage detection voltage Vsup in accordance with changes or fluctuations in the level of the supply voltage VCC.

The temperature detection circuitry 108 may be configured to detect a level of a device temperature of the electronic device, and generate a temperature detection voltage Vtemp that indicates the detected level. The device temperature may be determined by the ambient or surrounding temperature and/or operation of the electronic device, as non-limiting examples. The level of the temperature detection voltage Vtemp may correspond to the detected level of the device temperature. Accordingly, the temperature detection circuitry 108 may change or adjust the level of the temperature detection voltage Vtemp in accordance with changes or fluctuations in the device temperature. An example configuration of the temperature detection circuitry 108 may include proportional to absolute temperature (PTAT) circuitry, although other configurations may be possible.

The process detection circuitry 110 may be configured to detect a process characterization of the electronic device. In general, due to imperfections in manufacturing processes, such as fabrication processes, circuit components of different chips may behave or operate differently relative to their design. For example, transistors of different chips may operate (e.g., switch) faster or slower relative to each other, which in turn may cause different electronic devices of the same design to operate differently. In this regard, chips of an electronic device may be characterized into one of plurality of process characterization categories. In one example, the process characterization categories include typical, fast, and slow. A chip characterized as being typical indicates that the switching speed of the transistors is within an expected or normal range. Fast and slow may be the corner cases, and refer to whether the transistors are operating faster or slower than expected, respectively.

The process detection circuitry 110 may be configured to generate a process detection voltage Vproc that indicates a detected process characterization of the chip on which the calibration system is configured and/or the electronic device generally. In one example configuration as shown in FIG. 1, the process detection circuitry 110 may include a ring oscillator 112 and a time-to-voltage (T-to-V) converter 114. The ring oscillator 112 may be configured to generate an oscillating voltage Vosc. The frequency at which the oscillating voltage Vosc oscillates may correspond to the process characterization. For examples, frequencies above a first threshold frequency may correspond to the fast process characterization, frequencies below a second threshold frequency may correspond to the slow process characterization, and frequencies in between the first and second frequency thresholds may correspond to the typical process characterization. The time-to-voltage converter may receive the oscillating voltage Vosc and in turn generate the process detection voltage Vproc at a level that corresponds to the frequency of the oscillating signal Vosc.

As previously described, the process characterization, device temperature, and supply voltage, alone or in combination, may affect the impedance of the I/O driver circuitry 102, and as such, cause the impedance to be at and/or change to an undesirable level. The calibration system 100 may further include an I/O driver calibration module 116 that is configured to generate an I/O driver calibration signal PVT_code[n:0] to calibrate the impedance of the I/O driver circuitry 102 to be at a desirable level. The I/O driver calibration module 116 may generate the I/O driver calibration signal PVT_code[n:0] based on the process, voltage supply, and temperature detection voltages Vproc, Vsup, and Vtemp in order to compensate for the process characterization, supply voltage, and/or temperature levels to the extent that they are causing the impedance to be at an undesirable level. In one example, the I/O driver calibration signal PVT_code[n:0] may be an (n+1)-bit digital value, although other types of signals, analog or digital, may be possible.

Rather than generate the I/O driver calibration signal PVT_code[n:0] directly based on the voltage levels of the process, supply voltage, and temperature detection voltages Vproc, Vsup, and Vtemp, the calibration system 100 may first compare each of the detection voltages Vproc, Vsup, and Vtemp with a reference voltage Vref, and the I/O driver calibration module 116 may then generate the I/O driver calibration signal PVT_code[n:0] based on the comparisons. In further detail, the calibration system 100 may include a reference generator 118 that is configured to generate a reference voltage Vref and comparator circuitry 120 that is configured to compare the reference voltage Vref with each of the detection voltages Vproc, Vsup, and Vtemp. The comparator circuitry 120 may include a first input terminal (e.g., a negative terminal) configured to receive the reference voltage Vref and second input terminal (e.g., a positive terminal) configured to receive the detection voltages Vproc, Vsup, and Vtemp. The comparator circuitry 120 may then generate and output process, supply voltage, and temperature comparison voltages Vcomp_p, Vcomp_v, and Vcomp_t based on and indicative of the comparisons of the reference voltage Vref and the detection voltages Vproc, Vsup, and Vtemp, respectively.

As shown in FIG. 1, the calibration system 100 may further include a digitizer 122 (e.g., an analog-to-digital converter) that is configured to convert the comparison voltages Vcomp_p, Vcomp_t, Vcomp_v to respective (n+1)-bit digital process, temperature, and supply voltage indication signals Vproc_code[n:0], Vtemp_code[n:0], and Vsup_code[n:0]. The process indication signal Vproc_code[n:0] may indicate a process characterization of the device, the temperature indication signal Vtemp_code[n:0] may indicate a device temperature level of the device, and the supply voltage indication signal Vsup_code[n:0] may indicate a supply voltage level of the device. The digitizer 122 may be configured to output the indication signals Vproc_code[n:0], Vtemp_code[n:0], and Vsup_code[n:0] to the I/O driver calibration module 116, and based on the indication signals Vproc_code[n:0], Vtemp_code[n:0], and Vsup_code[n:0], the I/O driver calibration module 116 may be configured to generate the calibration signal PVT_code[n:0].

In the example configuration shown in FIG. 1, the comparator circuitry 120 and the digitizer 122 may be components of PVT indication generation circuitry 124 that, in general, is configured to generate process, temperature, and supply voltage indication signals for further analysis by the I/O driver calibration module 116 by comparing the detection voltages Vproc, Vsup, and Vtemp with a reference voltage Vref. In other example configurations, the digitizer 122 may be part of the I/O driver calibration module 116. In still other example configurations, the digitizer 122 may be omitted, and the comparator circuitry 120 may be configured to output the comparison voltage Vcomp_p, Vcomp_t, Vcomp_v directly to the I/O calibration driver circuitry 116.

In addition, the comparator circuitry 120 may be configured to alternatingly compare the detection voltages Vproc, Vsup, and Vtemp with the reference voltage Vref. In one example configuration, the calibration system 100 may include a multiplexer 126 that is configured to receive the detection voltages Vproc, Vsup, and Vtemp from the detection circuits 106, 108, and 110. The multiplexer 126 may be configured to select and pass one of the detection voltages Vproc, Vsup, and Vtemp to the comparator circuitry 120, while unselecting and not passing the other two to the comparator circuitry 120. In this way, the comparator circuitry 120 may compare the detection voltages Vproc, Vsup, and Vtemp with the reference voltage Vref one at a time. Configurations other than the multiplexer 126 may be used to selectively pass the detection voltages Vproc, Vsup, and Vtemp to the comparator circuitry 120. Still other configurations may utilize multiple comparator circuitries each configured to receive one of the detection voltages Vproc, Vsup, and Vtemp such that selection circuitry is not used. In general, various circuit configurations for generation of an I/O driver calibration signal based on comparing detection voltages Vproc, Vsup, and Vtemp with a reference voltage Vref may be possible.

The calibration system 100 may further include a calibration control module 128 that is configured to control the calibration process. As shown in FIG. 1, the calibration controller 128 may be configured to generate and output a selectin signal Vsel to control which of the detection voltages Vproc, Vsup, and Vtemp the multiplexer 126 outputs to the comparator circuitry 120. In addition, the calibration control module 128 may be configured to generate and output process calibration, temperature calibration, and supply voltage calibration enable signals Proc_calib, Temp_calib, Volt_calib to respective process detection circuitry 110, temperature detection circuitry 108, and supply voltage detection circuitry 106 in order to enable and disable each of the detection circuitries 110, 108, 106. When enabled, each of the detection circuitries 110, 108, 106 may be configured to generate and output their respective detection voltages Vproc, Vtemp, and Vsup, and when disabled, each of the detection circuitries 110, 108, 106 may be disabled and prevented from generating and outputting their respective detection voltages Vproc, Vtemp, and Vsup.

When the calibration control module 128 determines to perform a process characterization identification portion of the calibration process, the calibration contol module 128 may output the calibration enable signals to enable the process detection circuitry 110 while disabling the supply voltage and temperature detection circuitry 106, 108. Additionally, the calibration control module 128 may output the selection signal Vsel such that the multiplexer 126 selects and passes the process detection voltage Vproc to the comparator circuitry 120. Similarly, when the calibration control module 128 determines to perform a supply voltage identification portion of the calibration process, the calibration control module 128 may output the calibration enable signals to enable the supply voltage detection circuitry 106 while disabling the process and temperature detection circuitry 110, 106. Additionally, the calibration control module 128 may output the selection signal Vsel such that the multiplexer 126 selects and passes the supply voltage detection voltage Vsup to the comparator circuitry 120. Likewise, when the calibration control module 128 determines to perform a device temperature identification portion of the calibration process, the calibration control module 128 may output the calibration enable signals to enable the temperature detection circuitry 108 while disabling the process and supply voltage detection circuitry 110, 108. Additionally, the calibration control module 128 may output the selection signal Vsel such that the multiplexer 126 selects and passes the temperature detection voltage Vtemp to the comparator circuitry 120.

In addition, when the calibration control module 128 determines to perform a calibration process (or at least a portion of the calibration process), the calibration control module 128 may generate and output a calibration flag or notification signal Flag_self_calib to the data transfer module 104 to stop or prevent the transfer of data with the I/O driver circuitry 102 so that the I/O driver circuitry 102 does not communicate data during the calibration process. When the calibration process ends (or the calibration process is otherwise not being performed), the calibration control module 128 may release the flag or output the notification signal Flag_self_calib to the data transfer module 104 such that the I/O driver circuitry 102 may resume or be enabled to communicate data.

An initial (or cold start) calibration process may involve the identification of all three of the process characterization, device temperature level, and supply voltage level. Subsequent calibration processes after the initial one may be performed due to changes or fluctuations in the device temperature level or the supply voltage level when the electronic device is operating. The calibration system 100 may consider the process characterization not to change during operation of the electronic device. Accordingly, after the initial calibration process, the calibration control module 128 may determine to perform the supply voltage identification portion and/or the device temperature identification portion, but not the process characterization identification portion of the calibration process.

The calibration control module 128 may be configured to monitor for changes or fluctuations in the device temperature level or the supply voltage level when the electronic device is operating in order to determine when to initiate a subsequent calibration process. As shown in FIG. 1, the calibration control module 128 may be configured to receive the temperature detection voltage Vtemp and the supply voltage detection voltage Vsup to detect any changes or fluctuations that would trigger performance of another calibration process. In addition or alternatively, as denoted by the dotted arrow 130, the calibration control module 128 may receive the temperature and supply voltage indication signals Vtemp_code[n:0], and Vsup_code[n:0] from the PVT indication generation circuitry 124 in order to determine whether to perform a subsequent calibration process.

If the calibration control module 128 determines to perform a subsequent calibration process, the calibration control module 128 may be configured to output the notification signal Flag_self_calib to the data transfer module 104 in order to stop or prevent the transfer of data with the I/O driver circuitry 102. After the subsequent calibration process is complete, the calibration control module 128 may then output the notification signal Flag_self_calib in order to resume or allow the communication of data with the I/O driver circuitry 102. Also, if a subsequent calibration process is performed, then the I/O driver calibration module 116 may be configured to generate a new or different calibration signal PVT_code[n:0] based on a change in the device temperature indication signal Vtemp_code[n:0] and/or the supply voltage indication signal Vsup_code[n:0] from the last time the calibration process is performed.

In some example configurations, the calibration control module 128 may be configured to control and/or initiate the initial and/or subsequent calibration processes in response to receipt of and/or by generating other interrupt or notification signals. For example, the calibration control module 128 may be configured to initiate the initial calibration process in response to detection of a power on reset (POR) signal indicating that the electronic device has exited or completed a power up or reset phase of operation. In addition or alternatively, the calibration control module 128 may be configured to utilize calibration start and calibration stop signals to start and stop the calibration processes. For example, prior to performing an initial portion of the calibration process (e.g., one of the process characterization, supply voltage level, or temperature level identification processes), the calibration control module 128 may set the calibration start signal to indicate the calibration process is proceeding. Also, for some example configurations, after a calibration process is complete (such as when the I/O driver calibration module 116 outputs a calibration signal PVT_code[n:0] to the I/O driver circuitry 102), the calibration control module 128 may set the calibration done signal to indicate that the calibration process has completed, the I/O driver calibration module 116 may output the calibration done signal to the calibration controller 128. In response, the calibration control module 128 may set the calibration start signal to indicate that the calibration process is no longer proceeding. Also, in some example configurations, the calibration done signal may be used instead of or in conjunction with the notification signal Flag_self_calb. For example, when a calibration process has completed, the I/O driver calibration module 116 may output the calibration done signal to the data transfer module 104 to resume or allow the communication of data with the I/O driver circuitry 102. Also, if the calibration control module 128 determines to perform a subsequent calibration process, the output of notification signal Flag_self_calib to instruct the data transfer module 104 to stop or prevent the communication of data with the I/O driver circuitry 102 may cause the calibration done signal to be set to a level to indicate that a calibration process is not completed. Various notification or interrupt signals may be used to perform the calibration processes.

In addition, the calibration processes may be considered self-calibration processes in that the calibration control module 128 may determine to perform the calibration processes on its own initiative without receipt of external inputs instructing the calibration control module 128 to perform a calibration process.

As previously described, the frequency of the oscillating signal Vosc output from the ring oscillator 112 may be indicative of the process characterization the device. However, the frequency of the oscillating signal Vosc may also depend on the voltage that is powering the ring oscillator 112 as well as the device temperature. As such, changes or variations in the device temperature or the voltage powering the ring oscillator 112 may cause changes or variations in the frequency of the oscillating signal Vosc and in turn the level of the process detection voltage Vproc.

For some chip technologies, the same process detection voltage level may indicate two different process characterizations for different sets of device temperature and supply voltage conditions. As a consequence, two different detection circuits of two different chips that have different process characterizations but that are operating under two different sets of device temperature and supply voltage conditions may output their respective process detection voltage at the same level. As a result, the I/O driver calibration circuitry 116 may incorrectly identify the process characterization or at least not know with certainty what the correct process characterization is. For example, the I/O driver calibration circuitry 116, depending on a value or level of the process indication signal Vproc_code[n:0], may incorrectly identify the process characterization as being typical when it is actually fast (or vice versa), or at least the I/O driver calibration circuitry 116 may not know with certainty whether the process characterization is fast or typical. Similarly, depending on a value or level of the process indications signal Vproc_code[n:0], the I/O driver calibration circuitry 116 may incorrectly identify the process characterization as being typical when it is actually slow (or vice versa), or at least the I/O driver calibration circuitry 116 may not know with certainty whether the process characterization is slow or typical. As a result, the I/O driver calibration module 116 may generate a calibration signal PVT_code[n:0] that does not accurately compensate or account for the process characterization.

As shown in FIG. 1, the calibration system 100 may include a regulator 132 that is configured to generate and output a regulated voltage Vreg to the ring oscillator 112 and the time-to-voltage converter 114. The regulator 132 may receive and be powered by the supply voltage VCC as shown in FIG. 1. The regulated voltage Vreg may be maintained by the regulator 132 at a more constant level compared to the supply voltage VCC, which may be noisy and/or have relatively large fluctuations. As a result, by powering the process detector circuitry 110 with the regulated voltage Vreg instead of the supply voltage VCC, any uncertainty or inaccuracy in identifying the correct process characterization due to changes or variations in the supply voltage VCC may be minimized or eliminated.

The calibration system 100 may further include a temperature band selection module 134 to similarly minimize or eliminate the uncertainty or inaccuracy in identifying the correct process characterization due to changes or variations in device temperature. In further detail, the temperature band selection module 134 may be configured to select one of a plurality of temperature bands corresponding to the device temperature. In the example configuration shown in FIG. 1, the temperature band selection module 134 may use the temperature indication signal Vtemp_code[n:0] output from the digitizer 122 to make the selection, although the other example configurations, the temperature band detection module 134 may use the temperature detection voltage Vproc or the temperature comparison voltage Vcomp_t to make the selection.

The plurality of temperature bands may span a range of possible device temperatures. An example range may be from −40 degrees Celsius to 150 degrees Celsius, although other ranges are possible. Each temperature band (or range) may have a lower bound level and an upper bound level, where the upper bound level of one temperature band may be adjacent or next to the lower bound level of the next or adjacent temperature band. The temperature bands may have the same size or width—that is, the temperature bands may increment in m-degree temperature increments over the range of possible device temperatures. As non-limiting examples, the temperature bands may increment in 5, 10, or 20-degree increments. Other configurations where the sizes of the temperature bands vary amongst each other may be possible.

Upon receipt of the temperature indication signal Vtemp_code[n:0], the temperature band selection module 134 may identify the device temperature that the temperature indication signal Vtemp_code[n:0] is indicating. The temperature band selection module 134 may then select a temperature band of the plurality of temperature bands that corresponds to the identified device temperature. A temperature band may correspond to an identified device temperature if the identified device temperature falls in or on the temperature band. To illustrate, suppose the temperature bands are configured in 10-degree increments, and further suppose a temperature indication signal Vtemp_code[n:0] indicates a device temperature of 43 degrees. Upon identifying 43 degrees as the device temperature, the temperature band selection module 134 may select a 40-50 degree temperature band since 43 degrees falls within the 40-50 degree temperature range.

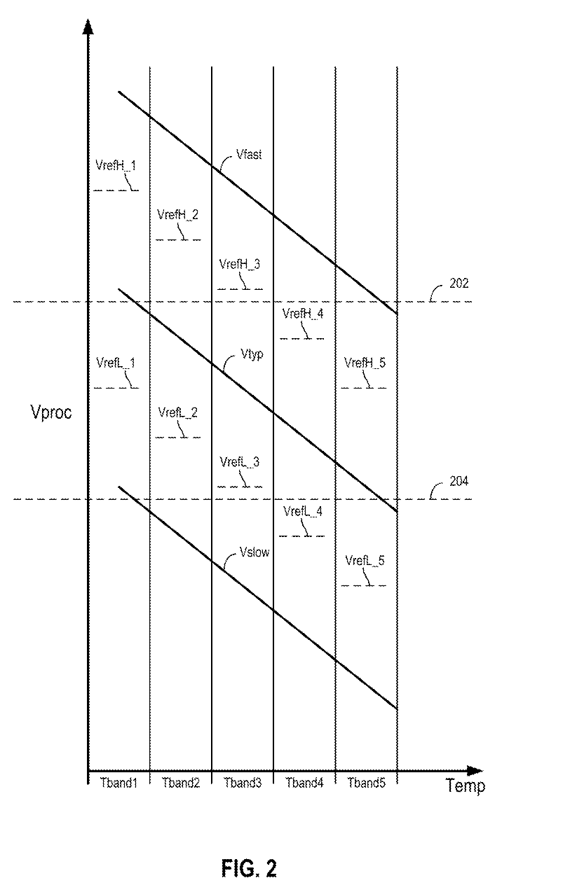

Each of the plurality of temperature bands may correspond to one of a plurality of reference voltage bands. Each reference voltage band (or range) may include an upper bound level and a lower bound level. The upper and lower bound levels may be used to determine whether the process characterization is typical, fast or slow. Setting the upper and lower bound reference levels based on the device temperature in order to identify a process characterization may minimize or eliminate the affect that temperature may have on the identification. Further description of the association between the temperature and reference voltage bands is provided with reference to FIG. 2.

FIG. 2 shows a schematic diagram of a plurality of voltage bands associated with a plurality of temperature bands with reference to process detection curves as functions of device temperature. As shown in FIG. 2, an inversely linear relationship may exist between process detection voltage and device temperature—i.e., as the device temperature linearly increases, the process detection voltage Vproc linearly decreases. The plot in FIG. 2 shows three linearly decreasing curves, including a first process detection curve Vfast associated with a fast process characterization, a second process detection curve Vtyp associated with a typical process characterization, and a third process detection curve Vslow associated with a slow process characterization. Depending on the level of the process detection voltage Vproc, the three curves Vfast, Vtyp, and Vslow may then be used or applied to determine the process characterization of the electronic device.

However, as shown in FIG. 2, some overlap among the curves Vfast, Vtyp and Vslow may exist across the range of device temperatures. For example, one process detection circuit having a fast process characterization and operating under a relatively high device temperature and another process detection circuit having a typical process characterization and operating under a relatively low device temperature may output their respective process detection voltages at the same level, such as the level identified by dotted line 202. Similarly, one process detection circuit having a typical process characterization and operating under a relatively high device temperature and another process detection circuit having a slow process characterization and operating under a relatively low device temperature may output their respective process detection voltages at the same level, such as the level identified by dotted line 204.

In order to alleviate the identification problem due to the curves overlapping, in the example configuration shown in FIG. 2, the temperature range is divided into five temperature bands, including a first temperature band Tband1, a second temperature band Tband2, a third temperature band Tband3, a fourth temperature band Tband4, and a fifth temperature band Tband5. More or fewer than five temperature bands may be possible for other example configurations. Each temperature band may have an associated reference voltage band defined or bounded by an upper bound level VrefH and a lower bound level VrefL. In particular, first upper and lower bound levels VrefH_1, VrefL_1 may define a first reference voltage band associated with the first temperature band Tband1, second upper and lower bound levels VrefH_2, VrefL_2 may define a second reference voltage band associated with the second temperature band Tband2, third upper and lower bound levels VrefH_3, VrefL_3 may define a third reference voltage band associated with the third temperature band Tband3, fourth upper and lower bound levels VrefH_1, VrefL_1 may define a fourth reference voltage band associated with the fourth temperature band Tband4, and fifth upper and lower bound levels VrefH_5, VrefL_5 may define a fifth reference voltage band ssociated with the first temperature band Tband5.

As shown in FIG. 2, the reference voltage bands may be different or unique amongst each other. That is, no two reference voltage bands have the same upper and lower bound levels VrefH, VrefL. In addition, the reference voltage bands may generally track the linearly decreasing process detection voltage levels. Accordingly a reference voltage band associated with a higher temperature band may have lower upper and lower bound levels VrefH, VrefL than those reference bands associated with lower temperature bands.

The upper and lower bound levels VrefH, VrefL may be used to identify the process characterization. For or within a given temperature band and associated reference voltage band, the upper bound level VrefH may be below the process detection voltages of the fast curve Vref and above the process detection voltages of the typical curve Vtyp, and the lower bound level VrefL may be below the process detection voltages of the typical curve Vtyp and above the process detection voltages of the slow curve Vslow. Accordingly, if a process detection voltage level is higher than an upper bound level VrefH, then the process characterization may be identified as being fast; if a process detection voltage level is lower than a lower bound level VrefL, then the process characterization may be identified as being slow; and if a process detection voltage level is in between the upper bound level VrefH and the lower bound level VrefL, then the process characterization may be identified as being typical.

Because each of the upper and lower bound levels VrefH, VrefL are in between two of the curves Vfast, Vtyp, Vslow for their respective temperature bands, then when a temperature band corresponding to a detected device temperature is selected, a process detection voltage Vproc may be compared with one or both of upper and lower bound levels VrefH, VrefL specific to the selected temperature band, and the level of the process detection voltage Vproc relative to the upper and lower bound levels VrefH, VrefL may indicate only one (not two) process characterization. As such, by separating the range of possible device temperatures into a plurality of temperature bands such that, within each of the temperature bands, the curves Vfast, Vtyp, Vslow do not overlap each other and upper and lower bounds VrefH, VrefL are set in between the curves Vfast, Vtyp, Vslow, any uncertainty or inaccuracy in identifying the correct process characterization due to the device temperature may be minimized or eliminated.

Referring back to FIG. 1, the temperature band detection module 134 may be configured to identify a detected device temperature upon receipt of the temperature indication signal Vtemp_code[n:0] and select a corresponding temperature band of the plurality of temperature bands. The temperature band selection module 134 may then generate a control signal Vctrl that identifies or indicates at least one of the upper or lower bound levels VrefH, VrefL of the reference band associated with the selected temperature band. The temperature band selection module 134 may output the control signal Vctrl to the reference generator 118.

In response to receipt of the control signal Vctrl, the reference generator 118 may output the reference voltage Vref at the upper bound level VrefH and/or the lower bound level VrefL indicated by the control signal Vctrl. In one example configuration, the reference generator 118 may initially output one of the upper or lower bound levels VrefH, VrefL, and subsequently output the other if doing so is needed for the I/O driver calibration module 116 to identify the process characterization. For example, suppose the reference generator 118 output the reference voltage Vref at the upper bound level VrefH, and the comparison performed by the comparator circuitry 120 indicates that a level of the process detection voltage Vproc is higher than the upper bound level VrefH. The I/O driver calibration module 116 may then identify the process characterization as being fast and no further comparisons may be necessary. Alternatively, if the comparison indicates that the level of the process detection voltage Vproc is lower than the upper bound level VrefH, then the reference generator 118 may subsequently output the reference voltage Vref at the lower bound level VrefL to determine whether the level of the process detection voltage Vproc is above the lower bound level VrefL (i.e., the process characterization is typical) or below the lower bound level VrefL (i.e., the process characterization is slow). Similar operations may be performed if the reference generator 118 first outputs the reference voltage Vref at the lower bound level VrefL rather than at the upper bound level VrefH.

In one example configuration, after receiving an initial process characterization indication signal Vproc_code[n:0], the I/O driver calibration module 116 may determine if another comparison is needed in order to identify the process characterization. If so, then the I/O driver calibration module 116 may output a reference band control signal Vband_ctrl, which may cause the reference generator 118 to output the reference voltage Vref at the other of the upper or lower bound level VrefH, VrefL.

In other example configurations, such as those that include multiple comparators for the comparator circuitry 120, the reference generator 118 may be configured to output two reference voltages simultaneously to two comparators, one at the upper bound level VrefH and another at the lower bound level VrefL. For these other example configurations, the I/O driver calibration module 116 may have the comparison information it needs to identify the process characterization after one round of comparisons, and as such, may not have to output the reference band control signal Vband ctrl to the reference generator 118 for another comparison.

Additionally, for some example configurations, the reference generator 118 may include a constant reference generator 136 that is configured to generate a constant reference voltage Vref_c. An example configuration for the constant reference generator 136 may be a bandgap voltage reference generator, although other configurations may be possible. The reference generator 118 may further include reference adjuster (or scaler) circuitry 138 that may be configured to receive the constant reference voltage Vref_c and the control signal Vctrl, and adjust the level of the reference voltage Vref_c according to the reference band information indicated in the control signal Vctrl in order to output the reference voltage Vref at the upper and/or lower bound levels VrefH, VrefL. The reference adjuster circuitry 138 may also be configured to receive the reference band control signal Vband_ctrl and change the level of the reference voltage Vref from the upper bound level VrefH to the lower bound level VrefL (or vice versa) in response to receipt of the reference band control signal Vband_ctrl.

In addition, for some example configurations, when the comparator circuitry 120 is performing comparisons with the temperature detection voltage Vtemp or the supply voltage detection voltage Vsup, the reference adjuster circuitry 138 may output the reference voltage Vref at the level of the constant reference voltage Vref_c. However, for other example configurations, the reference adjuster circuitry 138 (or the reference generator 118 in general) may be configured to output the reference voltage Vref at levels other than the constant reference voltage level for the comparisons involving the temperature and/or supply voltage detection voltages Vtemp, Vsup.

Also, the reference generator 118 may be on-chip or internal with the other circuit components of the calibration system 100. This way, components used to generate a reference, such as a resistor or a clock generator, that are external to the electronic device may not be needed for PVT calibration.

Additionally, in general, a module as it is used herein (such as for the calibration control module 128, the temperature band selection module 134, the I/O driver calibration module 116, and the data transfer module 104) may be hardware or a combination of hardware and software. For example, each module may include an application specific integrated circuit (ASIC), a field programmable gate array (FPGA), a controller, a circuit or circuitry, a digital logic circuit, an analog circuit, a combination of discrete circuits, gates, or any other type of hardware or combination thereof. In addition or alternatively, each module may include memory hardware that comprises instructions executable with a processor or processor circuitry to implement one or more of the features of the module. When any one of the module includes the portion of the memory that comprises instructions executable with the processor, the module may or may not include the processor. In some examples, each module may just be the portion of the memory that comprises instructions executable with the processor to implement the features of the corresponding module without the module including any other hardware. Because each module includes at least some hardware even when the included hardware comprises software, each module may be interchangeably referred to as a hardware module. In addition, although the calibration control module 128, the temperature band selection module 134, the I/O driver calibration module 116, and the data transfer module 104 are shown as separate modules, in other example configurations, two or more of the modules may be considered or identified as being part of the same or a single module.

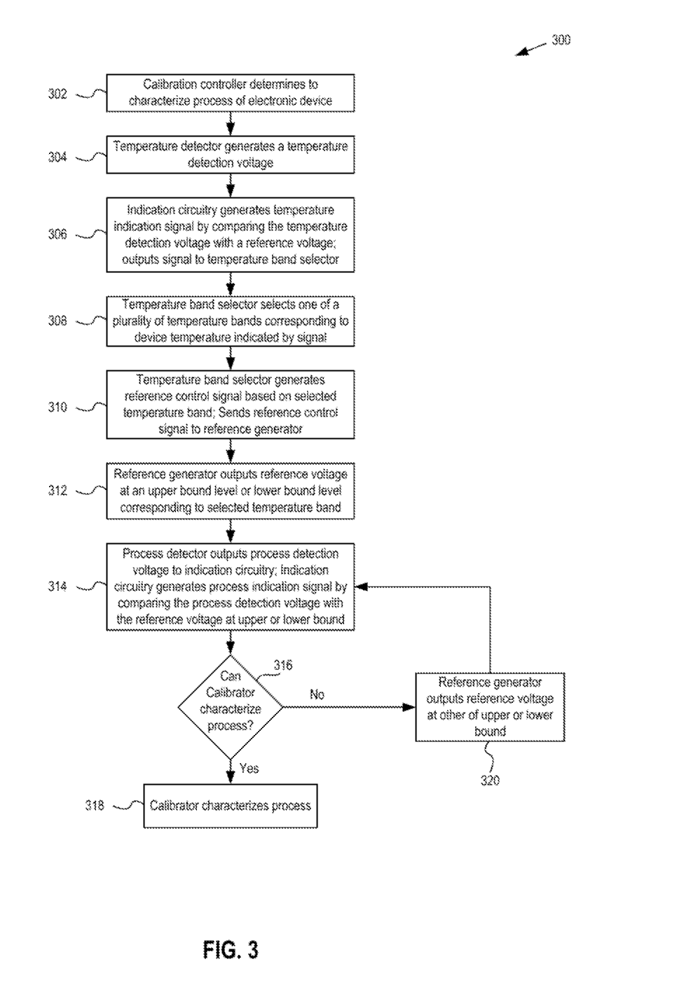

FIG. 3 shows a flow chart of an example method 300 of determining a process characterization. At block 302, a calibration control module may determine to identify a process characterization of an electronic device. The calibration control module may make the determination in response to a power up or reset process ending, detection of a POR signal, or the initial setting of a calibration start signal to indicate that a calibration process has started, as non-limiting triggering event examples. At block 304, temperature detection circuitry may generate and output a temperature detection voltage indicative of a detected device temperature. At block 306, indication circuitry may generate a temperature indication signal by comparing the temperature detection voltage with a reference voltage output from a reference generator. The indication circuitry may output the temperature indication signal to a temperature band selection module.

At block 308, the temperature band selection module may receive the temperature indication signal and upon receipt, identify a device temperature indicated by the temperature indication signal, and select one of a plurality of temperature bands corresponding to the device temperature. At block 310, the temperature band selection module may generate a reference control signal based on the selected temperature band. The reference control signal may indicate a reference band associated with the selected temperature band and/or upper and lower bound levels of the associated reference band. The temperature band selection module may output the reference control signal to the reference generator.

At block 312, the reference generator may output a reference voltage at the upper bound level or the lower bound level of the associated reference band to an input terminal of the comparator circuitry. At block 314, process detection circuitry may output a process detection voltage indicative of process characterization it has detected and/or a frequency of an oscillating signal output by a ring oscillator of the process detection circuitry. In some example methods, the ring oscillator may output the oscillating signal in response to receiving a regulated supply voltage rather than an external supply voltage. The indication circuitry may compare the process detection voltage and the reference voltage, and based on the comparison, generate a process characterization indication signal indicative of a process characterization of the electronic device. The indication circuitry may output the process characterization indication signal to an I/O calibration control module.

At block 316, the I/O calibration control module may determine whether it can identify the process characterization. If the determination is being made in response to an initial comparison performed by the indication circuitry, then the I/O calibration module may be able to identify the process characterization if the process characterization signal indicates that the process detection voltage is higher than the upper bound level or lower than the lower bound level. If it can, then the method may proceed to block 318, where the I/O driver calibration module identifies the process characterization.

Alternatively, at block 316, if it cannot, then at block 320, the reference generator may output the reference voltage at the other of the upper bound level or the lower bound level. The method may then proceed back to block 314, where the indication circuitry generates another process characterization signal based on a subsequent comparison of the process detection voltage and the reference voltage at the other of the upper and lower bound levels. At block 316, the I/O driver calibration module may now have enough information to identify the process characterization, and so the method may proceed to block 318, where the I/O calibration module identifies the process characterization.

Other or variations of the example method 300 of FIG. 3 may be possible. For example, when the calibration control module determines to identify the process characterization, a default or previously detected device temperature may be used, and so the method may proceed from block 302 directly to block 308 where the temperature band selection module selects a corresponding temperature band. In addition or alternatively, at block 312, the reference generator may output two reference voltages simultaneously, one at the upper bound level and one at the lower bound level to two comparators. Then, at block 314, the indication circuitry may output one or more process characterization signals based on the two comparisons to the I/O driver calibration module. The method may then proceed directly to block 318, where the I/O driver calibration module may identify the process characterization.

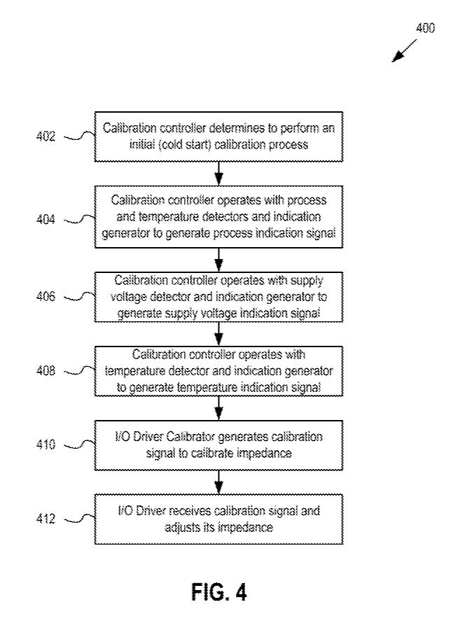

FIG. 4 shows a flow chart of an example method 400 of performing an initial (or cold start) PVT calibration process. At block 402, a calibration control module may determine to perform an initial calibration process for an electronic device. For some example methods, the determination may be made in response detecting a POR signal indicating a power up or reset phase of the electronic device has ended. At block 404, a process characterization identification portion of the PVT calibration process may be performed, during which the calibration control module may operate with a process detection circuitry, temperature detection circuitry, and an I/O driver calibration module to generate a process characterization indication signal as described above with reference to FIGS. 1 and 2 and/or with the method 300 of FIG. 3. The PVT indication generation circuitry may output the process characterization indication signal to the I/O driver calibration module.

At block 406, after the process characterization portion of the PVT calibration process is finished, a supply voltage identification portion of the PVT calibration process may be performed, during which the calibration control module may operate with supply voltage detection circuitry and the PVT indication generation circuitry to generate a supply voltage indication signal as described above with reference to FIG. 1. The PVT indication generation circuitry may output the supply voltage indication signal to the I/O driver calibration module. At block 408, after the supply voltage identification portion is finished, a device temperature identification portion of the PVT calibration process may be performed, during which the calibration control module may operate with the temperature detection circuitry and the PVT indication generation circuitry to generate a temperature indication signal as described above with reference to FIG. 1. The PVT indication generation circuitry may output the temperature indication signal to the I/O driver calibration module.

At block 410, after the device temperature identification portion of the PVT calibration process is performed, the I/O driver calibration module may generate a I/O driver calibration signal based on the process characterization, supply voltage level, and device temperature level identified by the process characterization, supply voltage, and temperature indication signals. The compensation signal may be set to a value to that sets or adjusts an impedance of the I/O driver circuitry to a desirable level in view of each of the identified process characterization, supply voltage level, and temperature level. The I/O driver calibration module may output the I/O driver calibration signal to the I/O driver circuitry. At block 412, the I/O driver circuitry may receive the I/O driver calibration signal, and in response, set or adjust its configuration in order to provide an impedance at a desirable level.

Other or variations of the example method 400 of FIG. 4 may be possible. For example, after the supply voltage identification portion of the calibration process is performed at block 406, the method may proceed directly to block 410 where the I/O driver calibration module 410 generates the calibration signal. This may occur for example methods where the I/O driver calibration module uses a device temperature value that it identified at block 402 to select a temperature band when generating the process characterization indication signal.

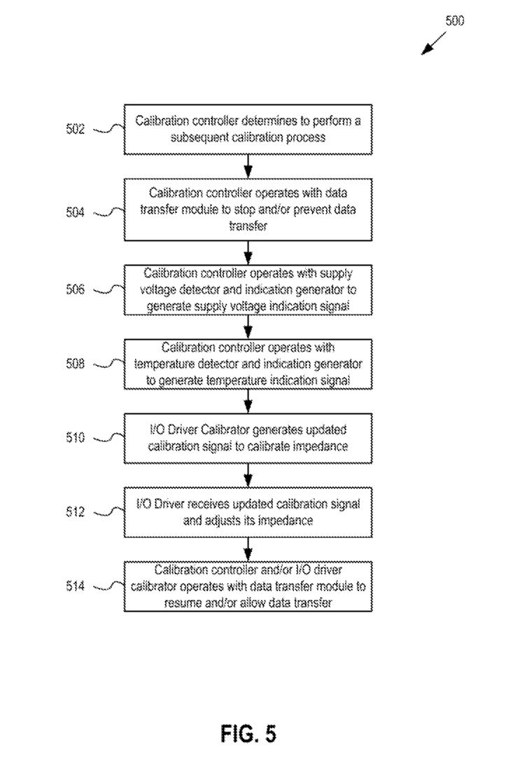

FIG. 5 is a flow chart of an example method 500 of performing a subsequent calibration process after an initial calibration process. At block 502, a calibration control module may determine to perform the subsequent calibration process. The calibration control module may do so in response to a determination that the device temperature level and/or the supply voltage level has changed to a degree that warrants the subsequent calibration process. At block 504, the calibration control module may notify a data transfer module of its decision to perform a subsequent calibration process, which may indicate to the data transfer module to stop or prevent data communication with I/O driver circuitry.

At block 506, a supply voltage identification portion of the subsequent calibration process may be performed, during which the calibration control module may operate with supply voltage detection circuitry and PVT indication generation circuitry to generate a supply voltage indication signal as previously described with respect to FIG. 1. The PVT indication generation circuitry may output the supply voltage indication signal to an I/O driver calibration module. At block 508, after the supply voltage identification portion is performed, a temperature identification portion of the subsequent calibration process may be performed, during which the calibration control module may operate temperature detection circuitry and the PVT indication generation circuitry to generate a device temperature indication signal as previously described with reference to FIG. 1. The PVT indication generation circuitry may output the temperature indication signal to the I/O driver calibration module.

At block 510, the I/O driver calibration module may generate a new or updated I/O driver calibration signal based on the supply voltage and temperature indication signals generated at blocks 506 and 508. The I/O calibration module may output the I/O driver calibration signal to the I/O driver circuitry. At block 512, the I/O driver circuitry may receive the I/O driver calibration signal, and in response, set or adjust its configuration in order to provide an impedance at a desirable level. At block 514, the calibration control module and/or the I/O driver calibration module may operate with the data transfer module to resume or allow data communication with the I/O driver circuitry.

Other methods that combine blocks of the methods 300, 400, 500 of FIGS. 3-5 may be performed. For example, the blocks of the method 300 may be performed at block 404 of the method 400 to generate a process characterization indication signal, as previously described. Another example method may combine the methods 400 and 500 of FIGS. 4 and 5, such that after the I/O driver calibration module generates an initial calibration signal and the I/O driver sets its impedance based on the calibration signal at block 410 and 412, the subsequent calibration method 500 of FIG. 5 may be performed. Other variations of the methods 300, 400, 500 of FIGS. 3-5 may be possible.

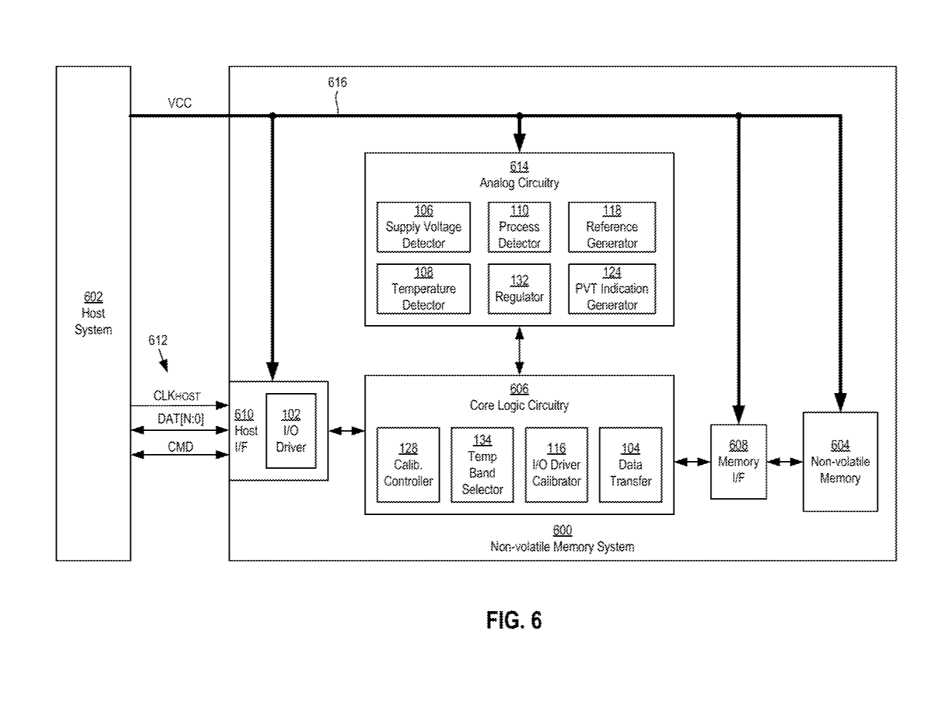

FIG. 6 shows a block diagram of an example non-volatile memory system 600 that may include the calibration system 100, the I/O driver circuitry 102, and the data transfer module 104 of FIG. 1, and be configured to perform the methods 300, 400, 500 of FIG. 3-5. The non-volatile memory system 600 may be configured to be connected to and/or in communication with a host system 602. The host system 306 may be any electronic system or device that is configured to communicate and/or operate with the non-volatile memory system 600.

The non-volatile memory system 600 may include non-volatile memory 604, which may include a plurality of non-volatile memory elements or cells, each configured to store one or more bits of data. The non-volatile memory elements or cells may be any suitable non-volatile memory cells, such as NAND flash memory cells and/or NOR flash memory cells in a two dimensional and/or three dimensional configuration. The memory cells may take the form of solid-state (e.g., flash) memory cells and can be one-time programmable, few-time programmable, or many-time programmable.

The non-volatile memory system 600 may also include core logic circuitry 606 that performs memory management functions for the storage of data in the non-volatile memory 604. Example memory management functions may include, but not limited to, communicating with the host system 602, including receiving, handling, and responding to host requests or commands, such as read, write, erase, and status requests/commands received from the host system 602; formatting the non-volatile memory 604 to ensure it is operating properly; mapping out bad memory cells; allocating spare cells to be substituted for future failed cells; and transitioning the non-volatile memory system 600 between different states, operation modes, and/or power consumption modes. In operation, when the host system 602 needs to read data from or write data to the non-volatile memory 604, it may communicate with the core logic circuitry 606.

In addition, non-volatile memory system 606 may include a memory interface (I/F) 608 that provides an interface between the core logic circuitry 606 and the non-volatile memory 604. The core logic circuitry 606 may be configured to communicate data and commands with the non-volatile memory 604 via the memory interface 608 to store data in and/or read data from the non-volatile memory 604. The non-volatile memory system 600 may also include a host interface 610 to communicate with the host system 602. The host interface 610 may be coupled to a communications bus 612 on which the interface 610 sends and receives signals to and from the host system 602. As shown in FIG. 6, the host interface 610 may include the I/O driver circuitry 102, which may be configured to generate the signals, such as by pulling up to a high level and pulling down to a low level voltages on the lines of the communications bus 612.

The communications bus 612 may include a host clock line _{CLKHOST} on which the host system 602 may send a host clock signal to the non-volatile memory system 600; an N-number of data lines DAT[N:0] on which the host system 602 and the non-volatile memory system 600 may communicate data signals with each other; and a command line CMD on which the host system 602 and the non-volatile memory system 600 may communicate command signals and responses with each other. The data signals may include data that the host system 602 wants stored in or read from the non-volatile memory system 600. Command signals sent from the host system 602 may instruct or request that the non-volatile memory system 600 perform some action, such as perform an operation, transition into a certain state, or respond with requested information, as examples. The response signals sent from the non-volatile memory system 600 may acknowledge receipt of the command signals, indicate that the instructed/action is performed, or include the requested information, as examples. The host clock signal may set the frequency of the communications bus 612 and/or control the data flow by providing the times and/or rates at which the clock and data signals may be sampled by the non-volatile system 600. Also, the host system 602 may supply a supply voltage VCC on a supply line 616 to power components of the non-volatile memory system 600.

The non-volatile memory system 600 may also include analog circuitry 614 that provides a plurality of regulator supply voltages to the core logic circuitry 606, including a core supply voltage. In addition, the analog circuitry 614 may provide a base clock signal and a core voltage stabilization signal indicating whether the core supply voltage is at a stable level. The core logic circuitry 606 may send one or more control signals to the analog circuitry 614 to configure, program, enable, and/or disable various components of the analog circuitry 614.

As shown in FIG. 6, in one example configuration, the supply voltage detection circuitry 106, the temperature detection circuitry 108, the process detection circuitry 110, the reference generator 118, the PVT indication generation circuitry 124 and the regulator 132 may be components of the analog circuitry 318. In addition, the data transfer module 104, the I/O driver calibration module 116, the calibration control module 128, and the temperature band selection module 134 may be components of the core logic circuitry 606. Other configurations for implementing the calibration system 100 in a non-volatile memory system that performs PVT calibration for I/O output driver circuitry may be possible.

In addition, similar configurations and methods may be implemented with electronic systems or devices other than non-volatile memory systems, including those that may communicate with a host system/device using I/O driver circuitry and that may include a calibration system that sets or adjusts an impedance of the I/O driver circuitry based on process, temperature, and/or supply voltage conditions. Such electronic devices or systems may include circuit components and modules similar to those described above.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

1. A system comprising:
a reference generator configured to output a reference voltage at a level based on a device temperature of an electronic device; and
indication circuitry configured to output a process indication signal based on a comparison of the reference voltage and a process detection voltage, wherein a level of the process detection voltage is indicative of a transistor speed of one or more transistors of the electronic device, and wherein the process indication signal indicates a transistor speed characterization of the electronic device.

2. The system of claim 1, further comprising a controller configured to:
receive a temperature indication signal from the indication circuitry, wherein the temperature indication signal indicates the device temperature of the electronic device;
generate a reference control signal based on the temperature indication signal; and
output the reference control signal to the reference generator,
wherein the reference generator is configured to output the reference voltage at the level based on receipt of the reference control signal.

3. The system of claim 2, wherein the controller is further configured to:
determine a temperature band of a plurality of temperature bands that corresponds to the device temperature indicated by the temperature indication signal; and
generate the reference control signal based on the determined temperature band,
wherein the level at which the reference generator is configured to output the reference voltage corresponds to the determined temperature band.

4. The system of claim 3, wherein the level at which the reference generator is configured to output the reference voltage is one of an upper bound level or a lower bound level of a reference voltage band corresponding to the determined temperature band.

5. The system of claim 4, wherein the reference generator is further configured to output the reference voltage at the other of the upper bound level or the lower bound level for a determination of the process characterization of the electronic device.

6. The system of claim 2, wherein the reference voltage comprises a first reference voltage, and wherein the indication circuitry is further configured to output the temperature indication signal based on a comparison of a second reference voltage and a temperature detection voltage output from a temperature detection circuit.

7. The system of claim 2, wherein the reference generator is further configured to, in response to receipt of the control signal, adjust a constant reference voltage to generate the reference voltage at the level.

8. The system of claim 1, further comprising a controller configured to:
receive the process identification signal;
generate an input/output (I/O) driver calibration signal based on the process identification signal; and
output the I/O driver calibration signal to an I/O driver circuit for calibration of an impedance of the I/O driver circuit.

9. The system of claim 1, further comprising:
a regulator configured to receive a supply voltage and generate a regulated voltage based on the supply voltage; and
process detection circuitry configured to generate the process detection voltage based on the regulated voltage.

10. The calibration system of claim 1, wherein the, reference generator and the comparator circuitry are configured on the same chip.

11-16. (canceled)

17. A system comprising:
a controller configured to:
select a temperature band of a plurality of temperature bands that corresponds to a detected temperature of an electronic device;
output a control signal for generation of a reference voltage at a level corresponding to the selected temperature band;
receive a process indication signal indicative of a level of a process detection voltage relative to the level of the reference voltage, wherein the process indication signal and the process detection voltage correspond to a transistor switching speed of the electronic device;
generate a calibration signal to calibrate an impedance of driver circuitry based on the process indication signal; and
output the calibration signal to the driver circuitry.

18. The system of claim 17, wherein the level of the reference voltage comprises one of an upper bound level or a lower bound level of a reference voltage band corresponding to the selected temperature band.

19. The system of claim 17, wherein the controller is further configured to identify a switching speed characterization of the electronic device based on comparing the process detection voltage and the reference voltage.

20. The system of claim 17, wherein the detected temperature is within the selected temperature band.

21. A system comprising:
means for receiving a temperature indication of a device temperature of an electronic device;
means for selecting a temperature band of a plurality of temperature bands that corresponds to a detected temperature of an electronic device;
means for outputting a reference voltage at a level that corresponds to the selected temperature band;
means for comparing a process detection voltage and the reference voltage, the process detection voltage indicative of a transistor speed of one or more transistors of the electronic device; and
means for setting an impedance of driver circuitry of the electronic device based on comparing the process detection voltage with the reference voltage.

22. The system of claim 21, wherein the level of the reference voltage comprises one of an upper bound level or a lower bound level of a reference voltage band corresponding to the selected temperature band.

23. The system of claim 22, further comprising:
means for outputting the reference voltage at the other of the upper bound level or the lower bound level of the reference voltage band; and
means for comparing the process detection voltage and the reference voltage at the other of the upper bound level or the lower bound level.

24. The system of claim 21, further comprising:
means for identifying a transistor speed characterization of the electronic device based on comparing the process detection voltage and the reference voltage,
wherein the means for setting the impedance of the driver circuitry is based on the transistor speed characterization.

25. The system of claim 21, further comprising:
means for detecting a change in the device temperature or a supply voltage level after the impedance is set; and
means for adjusting the impedance of the driver circuitry to compensate for the detected change in the device temperature or supply voltage level.

26. The system of claim 21, further comprising:
means for adjusting a constant reference voltage to generate the reference voltage at the level corresponding to the selected temperature band.
